(19) United States
(12) Patent Application Publication
(10) Pub. No.: US 2026/0112943 A1
(43) Pub. Date: Apr. 23, 2026

(54) ROTATING MACHINE

(71) Applicant: MEIDENSHA CORPORATION, Tokyo (JP)

(72) Inventor: Taku UEMATSU, Tokyo (JP)

(21) Appl. No.: 19/165,937

(22) PCT Filed: Mar. 8, 2024
(86) PCT No.: PCT/JP2024/009089

§ 371 Date: Sep. 16, 2025

(30) Foreign Application Priority Data
Mar. 17, 2023 (JP) 2023-042992

(51) Int. Cl. H02K 9/19; H02K 21/14

(52) U.S. Cl. CPC H02K 9/19; H02K 21/14

(57) ABSTRACT

A rotating machine has a rotor and a stator that faces the radial outer side of the rotor via a gap. The stator has a stator coil and a stator core having a slot accommodating the coil. The stator has a thin film member covering at least a portion of an inner circumferential surface of the core, and having a window unit exposing the core to the radial inner side. A cylindrical unit covers the inner peripheral surface of the core on both axial sides of the window. The thin film member has a radiating unit that expands to the radial outer side from the cylindrical unit across a side wall of the slot. The thin film member has a first flow path that reaches from the window unit to the radial outer side of the cylindrical unit, and extends to both axial ends along the radiating unit.

### BACKGROUND OF THE INVENTION

### Field of the Invention

The present invention relates to a rotating machine.

### Description of the Related Art

Conventionally, in the cooling of rotating machines, a method is known in which oil that serves as a coolant is directly applied to coil ends of a stator coil. However, in this method, there is the problem that it is easy for the coil temperature to rise in the portions of the stator coil other than the coil ends, in particular, in the vicinity of the center in the axial direction inside a slot of the stator core.

In relation to this, in the invention that is disclosed in Patent Publication No. 1, a configuration is disclosed in which a central hole that extends in the axial direction is provided in the shaft, a plurality of through holes that extends from the central hole to the outer peripheral surface of the shaft in the vicinity of the center in the axial direction is further provided, and additionally, a coolant flow path that communicates with the outer peripheral surface from the inside of the rotor and the stator is also provided. According to this configuration, it is possible to provide the coolant to the stator via the coolant path of the rotor in the axial direction position of the through holes that extend to the outer peripheral surface of the shaft by providing the coolant from the axial direction of the shaft, the stator core is cooled in the vicinity of the center in the axial direction inside of the slot of the stator core, and in addition, it is made such that the coil ends are cooled by the coolant that has flowed along the outer peripheral surface of the stator core.

### DESCRIPTION OF THE RELATED ART

### Prior Art Publications

### Patent Publications

[Patent Publication 1] Japanese Unexamined Patent Application, First Publication No. 2021-97556

### SUMMARY OF THE INVENTION

### Problem of the Invention

However, in Patent Publication No. 1, the coolant flow path must be formed in the rotor and the stator, and there is the problem that the manufacturing process is complex. In addition, there is also the problem that if the number of through holes that extend to the outer peripheral surface of the shaft is small, there is a possibility that irregularities will occur in the cooling in the circumferential direction of the rotor, and in contrast, if the number of through holes is increased, the mechanical strength will decrease. Therefore, conventionally, there has been room for improvement in the cooling structures of rotating machines.

The present invention aims to improve the cooling structure of a rotating machine.

### Means for Solving the Problem

The rotating machine according to one mode of the present invention is a rotating machine having a rotor, and a stator that faces the radial outer side of the rotor via a gap; wherein the stator has a stator coil, and a stator core having a slot that accommodates the stator coil; the stator further having a thin film member that covers at least a portion of the inner peripheral surface of the stator core; wherein the thin film member has a window unit in the center of the axial direction from which the stator core is exposed to the radial inner side, and a cylindrical unit that covers the inner peripheral surface of the stator core on both sides in the axial direction of the window unit; wherein the thin film member also has a radiating unit that expands from the cylindrical unit to the radial outer side along an outer wall of the slot; and the thin film member has a first flow path that leads to a radial outer side of the cylindrical unit from the window unit, and extends in the axial direction on both ends along the radiating unit.

In the rotating machine of the above described mode, the rotor has a shaft that becomes a rotational axis; a first rotor core that has been fixed on one side in the axial direction of the shaft; a second rotor core that has been fixed on the other side in the axial direction of the shaft; a ring member wherein the inner peripheral surface of the ring member has been fixed to the outer peripheral surface of the shaft by the ring member being sandwiched between the first rotor core and the second rotor core; the shaft further having a second flow path that extends in the axial direction from at least one end in the axial direction to the center in the axial direction; and a third flow path that passes through the axial outer side from the second flow path; wherein the ring member is positioned such that the axial position of the ring member corresponds with the third flow path in the axial direction; the ring member further has a fourth flow path that is in communication with the third flow path on the inner peripheral surface of the ring member and is recessed on the radial outer side across the entire circumference in the circumferential direction, and a fifth flow path that passes through the radial outer side from the fourth flow path; and wherein an opening on the radial outer side of the fifth flow path faces the window unit in the axial direction.

In the above-described one mode of the rotating machine, the shaft has a plurality of the third flow paths at regular intervals in the circumferential direction, and the ring member has a plurality of the fifth flow paths at regular intervals in the circumferential direction.

In the above-described one mode of the rotating machine, the number of the fifth flow paths is larger than the number of the third flow paths.

In the above-described one embodiment of the rotating machine, the rotor has a first magnet that has been embedded in the first rotor core, and a second magnet that has been embedded in the second rotor core, and the ring member is positioned more towards the radial inner side than the positions in the radial direction in which the first magnet and the second magnet have been embedded.

### Effect of the Invention

According to one mode of the present invention, it is possible to improve the cooling structure of the rotary machine.

### BRIEF DESCRIPTION OF THE DRAWINGS

FIG. 1 is a cross-section diagram of a motor according to a First Embodiment of the present invention.

FIG. 2 is a cross-section diagram in which a motor 100 has been cut on a different surface than the cross section in FIG. 1.

FIG. 3 is a perspective diagram of a ring member 108.

FIG. 4 is a perspective diagram of a stator 101 in a state in which a rotor 102 has been removed from the motor 100, and the inner peripheral surface can be seen.

FIG. 5 is a cross-section diagram showing the stator 101 of FIG. 4 in which it has been cut at a surface that is parallel to a Z axis.

### DESCRIPTION OF THE EMBODIMENTS

Below, the rotary machine according to embodiments of the present invention will be explained with reference to the diagrams. Note that in the diagrams below, in order to make each configuration easy to understand, there are cases in which the scale of each structure, the number of each structure, and the like have been made different than those of the actual structures. In addition, in order to make each configuration easy to see, they have been shown using outlines that are different than the actual shapes of the configurations.

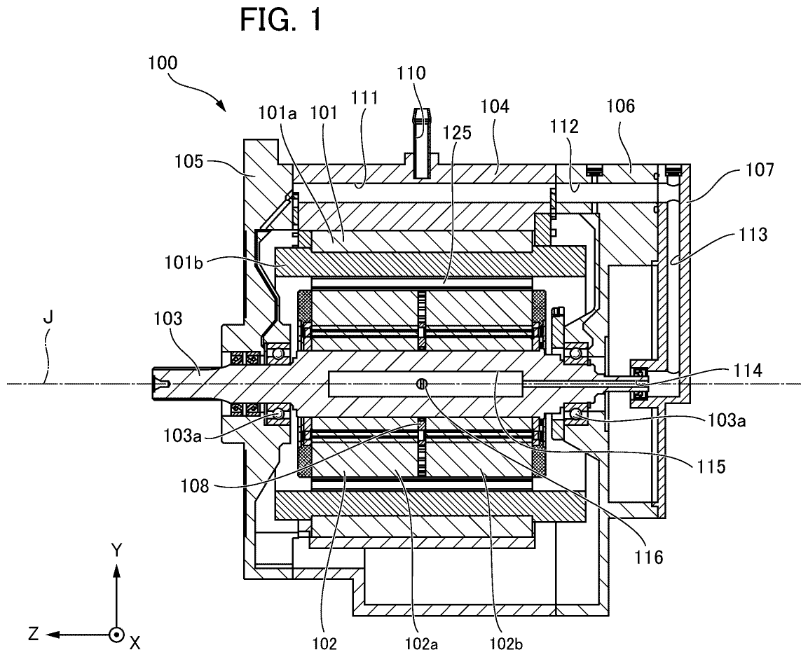

In addition, in the figures, an XYZ coordinate system is shown to serve as an appropriate 3-dimensional orthogonal coordinate system. In this XYZ coordinate system, the Z axis direction is made a direction that is parallel to the axial direction of a central axis J, which is shown in FIG. 1. The Y axis direction is made the vertical direction in FIG. 1 from among the radial directions in relation to the central axis J. The X axial direction is made the direction that is orthogonal to both the Y axis direction and the Z axis direction. In all of the X axis direction, the Y axis direction, and the Z axis direction, the sides that are indicated by the arrows shown in the diagrams are the +sides, and the opposite sides of these are made the −sides.

In addition, in the following explanation, the positive side of the Z axis direction (+Z side) is referred to as “one side”, and the negative side of the Z axis direction (−Z side) is referred to as the “other side”. Note that “one side” and the “other side” are simply names used for this explanation, and the actual positional relationship and directions thereof are not limited. In addition, unless otherwise specifically noted, the direction that is parallel to the central axis J (the Z axis) will simply be referred to as “the axial direction”, the radial direction with the central axis J as its center will be simply referred to as “the radial direction”, and the circumferential direction with the central axis J as its center, that is, the axial circumference of the central axis J, will be referred to simply as “the circumferential direction”. The side approaching the central axis J in the radial direction will be referred to as “the radial inner side”, and the side moving away from the central axis J will be referred to as “the radial outer side”.

Note that in the present specification “extends in the axial direction” also includes cases in which an article extends in a direction that has been inclined in a range that is less than 45° in relation to the axial direction in addition to cases in which the article extends strictly in the axial direction (the Z axis direction). In addition, in the present specification, “extends in the radial direction” also includes cases in which an article extends in a direction that has been inclined in a range that is less than 45° in relation to the radial direction in addition to cases in which the article extends strictly in the radial direction, that is, in which the article extends in a direction that is perpendicular to the axial direction (the Z axis direction). In addition, “parallel” also includes cases in which the angle created by the two articles has been inclined in a range that is less than 45° in addition to cases in which the articles are strictly parallel.

### First Embodiment

FIG. 1 is a cross-section diagram of the motor according to the First Embodiment of the present invention. FIG. 1 is a diagram that shows the motor as having been cut on a surface that follows the central axis J and is orthogonal to the X axis. The motor 100 is one example of a rotating machine according to the present invention. The motor 100 is an inner rotor type radial gap motor.

The motor 100 has a rotor 102 and a stator 101 with a cylindrical shape that faces the radial outer side of the rotor 102 via a gap. The motor 100 has a case 104 with a cylindrical shape. The stator 101 and the rotor 102 are accommodated in the case 104. The motor 100 has a bracket 105 that plugs one side in the axial direction of the case 104; a bracket 106 that plugs the other side in the axial direction of the case 104; and an auxiliary member 107 that is positioned on the other side in the axial direction of the bracket 106. The bracket 105 is fixed to the case 104. The bracket 106 is fixed to the case 104. The auxiliary member 107 is fixed to the bracket 106.

The case 104 has a supply port 110 for supplying oil that serves as a coolant from an external unit; and a flow path 111 that is in communication with the supply port 110. The flow path 111 extends in the axial direction. The bracket 106 has a flow path 112 that extends in the axial direction. One end in the axial direction of the flow path 112 is in communication with the other end in the axial direction of the flow path 111. The auxiliary member 107 has a flow path 113 that extends in the radial direction. The radial outer side end of the flow path 113 is in communication with the other end in the axial direction of the flow path 112.

The rotor 102 has a shaft 103 that becomes the rotational axis; a rotor core 102a that is fixed to one side in the axial direction of the shaft 103; a rotor core 102b that is fixed to the other side in the axial direction of the shaft 103; and a ring member 108 that has been sandwiched between the rotor core 102a and the rotor core 102b.

The shaft 103 extends along the central axis J. The shaft 103 is pivotally supported by a bearing 103a, and is rotatably supported in relation to the bracket 105 and the bracket 106. The shaft 103 has a flow path 114 that extends to one side in the axial direction from the other end in the axial direction. The end of the other side in the axial direction of the flow path 114 is in communication with the end of the inner side in the radial direction of the flow path 113. The shaft 103 has a flow path 115 that extends in the axial direction. The end of the other side in the axial direction of the flow path 115 is in communication with the end of the one side in the axial direction of the flow path 114. The flow path 115 extends until at least the center of the axial direction. The end of the one side in the axial direction of the flow path 115 is plugged. The flow path 114 and the flow path 115 have the same axis as the shaft 103. The diameter of the flow path for the flow path 115 is larger than the diameter of the flow path for the flow path 114. The shaft 103 has a flow path 116 that is in communication with the outer side in the radial direction from the flow path 115.

The stator 101 has a stator coil 101, and a stator core 101a that has a slot 101ab that accommodates a stator coil 101b. The stator 101 has a thin film member 125 that covers at least a portion of the inner peripheral surface of the stator core 101a. The thin film number 125 is, for example, a member made from resin. The details of the thin film member 125 will be explained below.

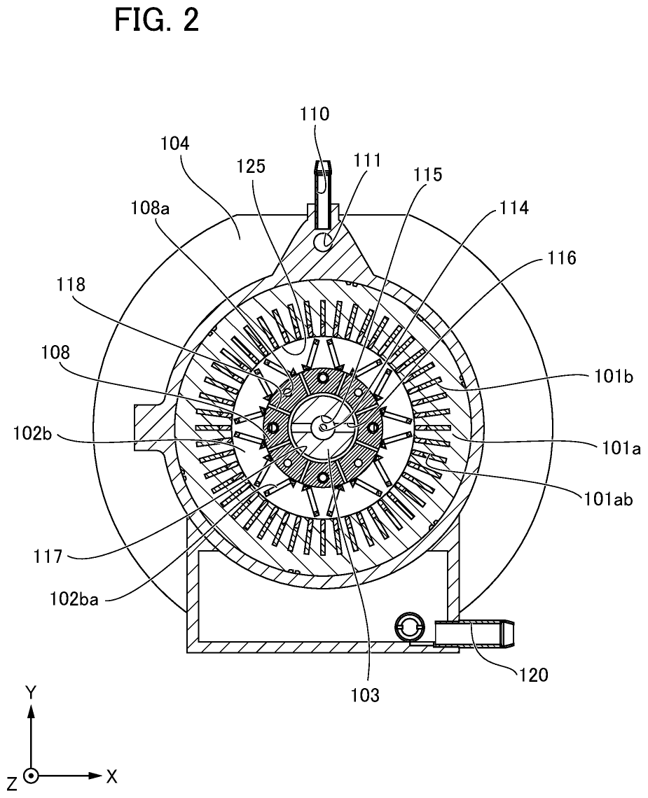

FIG. 2 is a cross-section diagram in which the motor 100 has been cut at a different surface than it was in FIG. 1. FIG. 2 is a diagram that shows the motor 100 as having been cut on a surface that is orthogonal to the Z axis along the flow path 118 of the ring member 108. As is shown in FIG. 2, in the present embodiment, the shaft 103 has two flow paths 116 at equal intervals in the circumferential direction.

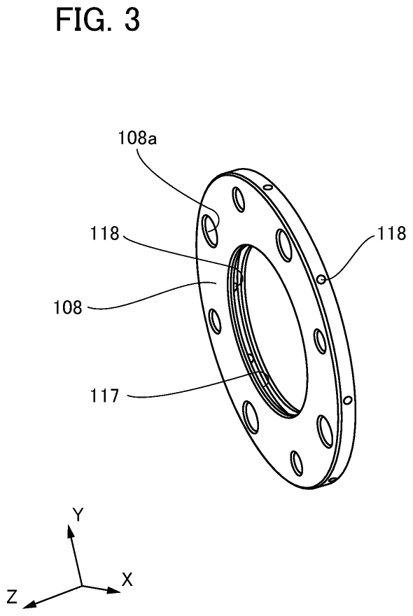

FIG. 3 is a perspective view diagram of the ring member 108. The ring member 108 is a flat, ring-shaped member. The ring member 108 has a plurality of fixing holes 108a in the circumferential direction that pass through the axial direction. The ring member 108 is fixed to, for example, the rotor core 102a and the rotor core 102b using the fixing holes 108a.

The inner peripheral surface of the ring member 108 is fixed to the outer peripheral surface of the shaft 103. The ring member 108 has a flow path 117 on its inner peripheral surface with a groove shape that is indented on the outer side in the radial direction across the entire circumference of the circumferential direction. The axial direction position of the ring member 108 is a position that corresponds with the flow path 116 in the axial direction, and the flow path 117 of the ring member 108 is in communication with the flow path 116.

The ring member 108 has a flow path 118 that passes through the outer side in the radial direction from the flow path 117. As is shown in FIG. 2, in the present embodiment, the ring member 108 has eight flow paths 118 at regular intervals in the circumferential direction. The number of flow paths 118 is larger than the number of flow paths 116. If the number of flow paths 116 is larger, there is a possibility that a problem will occur with respect to the mechanical strength of the shaft 103. In contrast, if the number of jetting ports that jet the coolant into the stator 101 from the shaft 103 is small, then there is a possibility that irregularities will occur in the cooling when cooling is being performed. According to the present embodiment, it is possible to decrease the irregularities in the cooling by making the number of flow paths 118, that is, the number of jetting ports that jet coolant into the stator 101, larger, while still maintaining the mechanical strength of the shaft 103 by making the number of the flow paths 116 small.

In addition, as is shown in FIG. 2, the rotor 102 has a magnet 102ba that has been embedded into the rotor core 102b. Although the rotor 102 has a magnet that has been embedded into the rotor core 102a in the radial direction position and the circumferential position, the same as the magnet 102ba, illustration thereof has been omitted. The ring member 108 is positioned more towards the radial inner side than the radial direction positions of the magnet 102ba that has been embedded into the rotor core 102b, and the magnet that has been embedded into the rotor core 102a. According to this configuration, the ring member 108 does not have an effect on the magnetic path of the magnet 102ba that has been embedded into the rotor core 102b, and the magnet that has been embedded into the rotor core 102a, and no loss (core loss) occurs.

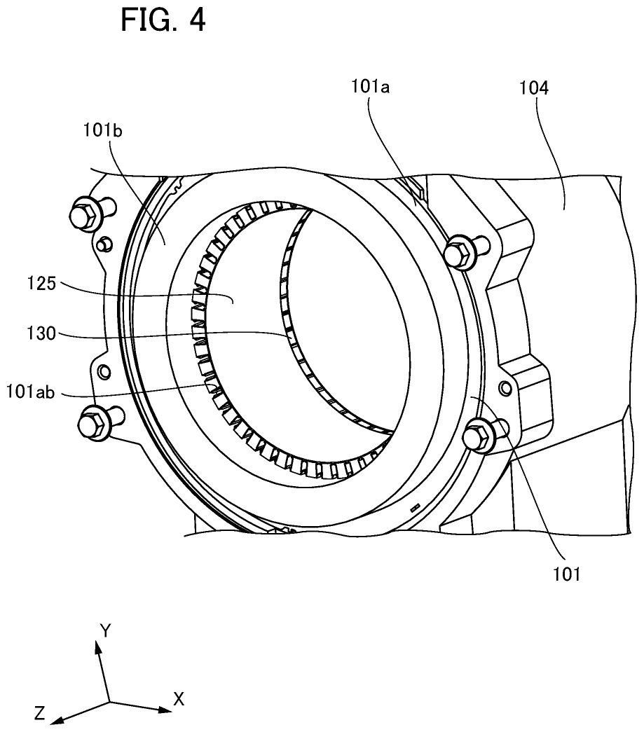

FIG. 4 is a perspective diagram of the stator 101 in a state in which the rotor 102 has been removed from the motor 100 and the inner peripheral surface can be seen. The thin film member 125, which is a thin film-shaped member, has a window unit 130 in the center of the axial direction that exposes the stator core 101a to the radial inner side.

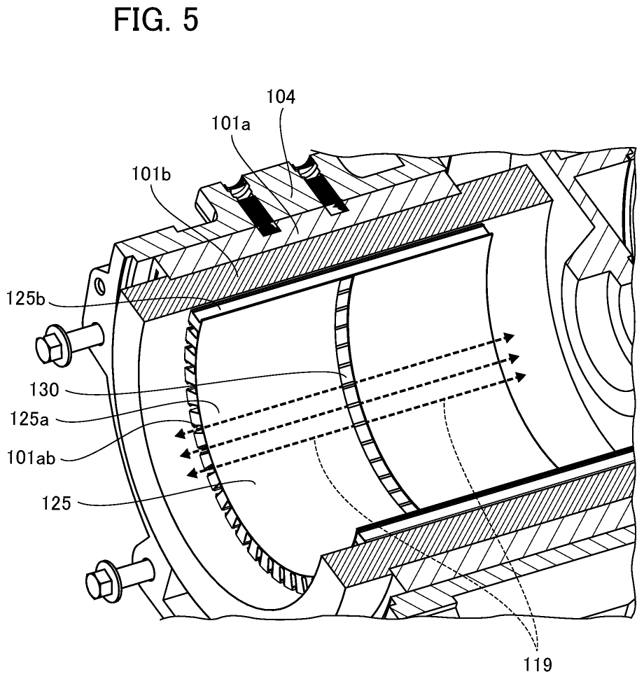

FIG. 5 is a cross section diagram showing the stator 101 of FIG. 4 as having been cut on a surface that is parallel to the Z axis. The thin film member 125 has a cylindrical unit 125a that covers the inner peripheral surface of the stator core 101a across the entire circumference in the circumferential direction on both sides in the axial direction of the window unit 130.

In addition, the thin film member 125 has a radiating unit 125b that expands from the cylindrical unit 125a to the radial outer side along the side wall of the slot 101ab. The thin film member 125 has a flow path 119 that leads from the window 130 to the radial outer side of the cylindrical unit 125a, and extends towards both ends in the axial direction along the radiating unit 125b. The opening on the radial outer side of the flow path 118 of the ring member 108 faces the window unit 130 in the axial direction.

According to the above-described configuration, the oil, which serves as a coolant that has been supplied to the supply port 110 from an external unit is flowed into the shaft 103 from the flow path 114 via the flow path 111, the flow path 112, and the flow path 113. Furthermore, the oil that has been flowed into the shaft 103 from the flow path 114 is flowed into the ring member 108 from the flow path 117 via the flow path 115 and the flow path 116. The oil that has been flowed into the ring member 108 from the flow path 117 is jetted toward the window unit 130 from the opening on the radial outer side of the flow path 118. The oil that has been jetted toward the window unit 130 flows to both axial ends via the flow path 119, and after having reached both of the coil ends of the stator coil 101b, runs off and is externally discharged from a discharge port 120.

The present invention is not limited by the above-describe embodiment, and various improvements and changes to the design may be made within a range that does not deviate from the gist of the present invention. In addition, it should be assumed that the embodiment that was disclosed herein does not exemplify all of the points of the present invention, and is not limiting. The scope of the present invention is indicated by the claims, not by the above-described explanation, and is intended to include all changes within a meaning and scope that are equivalent to the scope of the claims.

The present application claims the benefit of priority from Japanese Patent Application No. 2023-042992, filed on Mar. 17, 2023, which is hereby incorporated by reference herein in its entirety.

### EXPLANATION OF THE REFERENCE NUMERALS

100 . . . motor, 101 . . . stator, 102 . . . rotor, 103 . . . shaft

1. A rotating machine having a rotor, and a stator that faces a radial outer side of the rotor via a gap; wherein the stator has a stator coil, and a stator core having a slot that accommodates the stator coil;
the stator further has a thin film member that covers at least a portion of an inner peripheral surface of the stator core;
the thin film member has a window unit in the center of the axial direction that exposes the stator core to the radial inner side, and a cylindrical unit that covers the inner peripheral surface of the stator core on both axial sides of the window unit;
the thin film member further has a radiating unit that expands to the radial outer side from the cylindrical unit along a side wall of the slot; and
the thin film member further has a first flow path that leads towards the radial outer side of the cylindrical unit from the window unit, and extends toward both axial ends along the radiating unit.

2. The rotating machine according to the claim 1, wherein
the rotor has a shaft that becomes a rotational axis, a first rotor core that has been fixed on one side in the axial direction of the shaft; a second rotor core that has been fixed on another side in the axial direction of the shaft; and a ring member having an inner peripheral surface that that has been fixed to the outer peripheral surface of the shaft by the ring member being sandwiched between the first rotor core and the second rotor core;
the shaft has a second flow path that extends in the axial direction from one axial end to at least the center of the axial direction; and a third flow path that passes through the radial outer side from the second flow path;
an axial position of the ring member corresponds with the position of the third flow path in the axial direction;
the ring member has a fourth flow path on the inner peripheral surface of the ring member that is in communication with the third flow path and is indented on the radial outer side across the entirety of the circumference in the circumferential direction, as well as a fifth flow path that passes through the radial outer side from the fourth flow path; and
an opening of the radial outer side of the fifth flow path faces the window unit in the axial direction.

3. The rotating machine according to claim 2, wherein
the shaft has a plurality of the third flow paths at regular intervals in the circumferential direction; and
the ring member has a plurality of the fifth flow paths at equal intervals in the circumferential direction.

4. The rotating machine according to claim 3, wherein
a number of the fifth flow paths is larger than a number of third flow paths.

5. The rotating machine according to claim 2, wherein
the rotor has a first magnet that has been embedded into the first rotor core, and a second magnet that has been embedded into the second rotor core; and
the ring member is positioned more toward the radial inner side than the radial position in which the first magnet has been embedded and the radial position in which the second magnet has been embedded.

6. The rotating machine according to claim 3, wherein
the rotor has a first magnet that has been embedded into the first rotor core, and a second magnet that has been embedded into the second rotor core; and
the ring member is positioned more toward the radial inner side than the radial position in which the first magnet has been embedded and the radial position in which the second magnet has been embedded.

7. The rotating machine according to claim 4, wherein
the rotor has a first magnet that has been embedded into the first rotor core, and a second magnet that has been embedded into the second rotor core; and
the ring member is positioned more toward the radial inner side than the radial position in which the first magnet has been embedded and the radial position in which the second magnet has been embedded.
